(19) United States
(12) Patent Application Publication
(10) Pub. No.: US 2010/0310948 A1
(43) Pub. Date: Dec. 9, 2010

(54) FUEL CELL SYSTEM WITH INTEGRATED AIR HANDLING PLATE

(75) Inventors: Nathan Ernst, Ann Arbor, MI (US); Thomas Waters, Ann Arbor, MI (US); Aaron T. Crumm, Ann Arbor, MI (US)

Correspondence Address: Adaptive Materials Inc., 5500 S. State Rd., Ann Arbor, MI, 48108, US

(73) Assignee: ADAPTIVE MATERIALS, INC., Ann Arbor, MI (US)

(21) Appl. No.: 12/479,333

(22) Filed: Jun. 5, 2009

(51) Int. Cl. H01M 8/18; H01M 8/10

(52) U.S. Cl. 429/416; 429/427

(57) ABSTRACT

A fuel cell system includes a fuel reformer configured to react a raw fuel and oxygen to produce a reformed fuel. The fuel cell system further includes a fuel cell configured to generate electricity by reacting oxygen at a first electrode and reformed fuel at a second electrode. The fuel cell system further includes a plate member at least partially defining an air chamber wall, an air chamber inlet, and an air chamber outlet. The air chamber is configured to route air to at least one of the fuel reformer and the first electrode of the fuel cell stack.

### GOVERNMENT INTERESTS

This invention was made with government support under contract number 2008*1177616*000, awarded by the U.S. Department of Defense. The government has certain rights in this invention.

### FIELD OF INVENTION

This invention is related to air flow management in solid oxide fuel cell systems.

### BACKGROUND

The statements in this section merely provide background information related to the present disclosure and may not constitute prior art.

Fuel cells can generate electricity be reacting a fuel and an oxidant on opposite electrodes of an electrochemical cell. Portable fuel cell systems can operate utilizing a raw fuel contained onboard. Raw fuel requires further processing prior to utilization by the electrochemical cell. Raw fuel can be refined through a process that includes filtering the raw fuel through a filter and reforming the raw fuel by reacting the raw fuel with an oxidant at an onboard reformer to partially oxidize the fuel. Once the raw fuel is processed, the fuel is suitable for use as a fuel cell fuel, that is, a fuel which can be utilized by the electrochemical cell.

Several components are utilized to process raw fuel to fuel cell fuel. Exemplary components include various pumps, blowers, fans, filters, reformers, and sensors, each of which can significantly increase the volume, weight, and overall cost of the fuel cell system. For example, there is significant volume, weight, and costs associated with components that deliver and control air flow to the anode and to the cathode of the fuel cell. The anode air flow stream is supplied to the onboard reformer and the anode air flow stream flow rate is controlled to control an air-to-fuel ratio to reform fuel by partial oxidation. To achieve the desired air-to-fuel ratio, the fuel cell systems includes anode air processing components including an air filter, controllable actuators, feedback control sensors, and various air delivery components. Further, fuel cell systems include fuel processing components including a fuel filter, controllable actuators, feedback control sensors, regulators, heating elements and expansion chambers and various fuel delivery components to deliver fuel to a proper locations within the fuel cell system where the fuel can mix with the anode air flow stream prior to delivery to the onboard reformer. The fuel cell system further includes components to direct reformed fuel from the onboard reformer to the fuel cell anode, thereby providing fuel for electrochemical fuel cell reactions.

Further, fuel cell systems can include components to provide other desirable operating characteristics. For example, the fuel cell system can include heat and energy management systems and can include components to dampen vibrational forces or mechanically isolated portions of the fuel cell system from vibration and shock. Design features that manage heat and energy and that provide robustness can further add to the overall weight, volume, and cost of the fuel cell system.

Therefore, there is a need for robust fuel cell systems with onboard reforming that is easy to manufacture, low cost, and that a have high power to volume ratio and a high power to weight ratio.

### SUMMARY

Disclosed herein in accordance with exemplary embodiments is a fuel cell system including a fuel reformer configured to react a raw fuel and oxygen to produce a reformed fuel. The fuel cell system further includes a fuel cell configured to generate electricity by reacting oxygen at a first electrode and reformed fuel at a second electrode. The fuel cell system further includes a plate member at least partially defining an air chamber wall, an air chamber inlet, and an air chamber outlet. The air chamber is configured to route air to at least one of the fuel reformer and the first electrode of the fuel cell stack. The first air actuator is configured to motivate air flow from the inner chamber to at least one of the fuel reformer and the first electrode of the fuel cell stack.

### FIGURES

FIGS. 1 and 2 are prospective views of a fuel cell system in accordance with an exemplary embodiment of the present disclosure;

FIG. 3 is an exploded view of the fuel cell system of FIG. 1;

FIG. 4 is a cutaway prospective view of the fuel cell system of FIG. 1; and

FIG. 5 is a prospective view of a lower plate member of an integrated plate member of the fuel cell system of FIG. 1;

It should be understood that the appended drawings are not necessarily to scale, presenting a somewhat simplified representation of various preferred features illustrative of the basic principles of the invention. The specific design features of the solid oxide fuel cell as disclosed here, including, for example, specific dimensions of the catalytic substrate will be determined in part by the particular intended application and use environment. Certain features of the illustrated embodiments have been enlarged or distorted relative to others for visualization and clear understanding. In particular, thin features may be thickened, for example, for clarity of illustration. All references to direction and position, unless otherwise indicated, refer to the orientation of the solid state electrochemical device illustrated in the drawings.

### DESCRIPTION

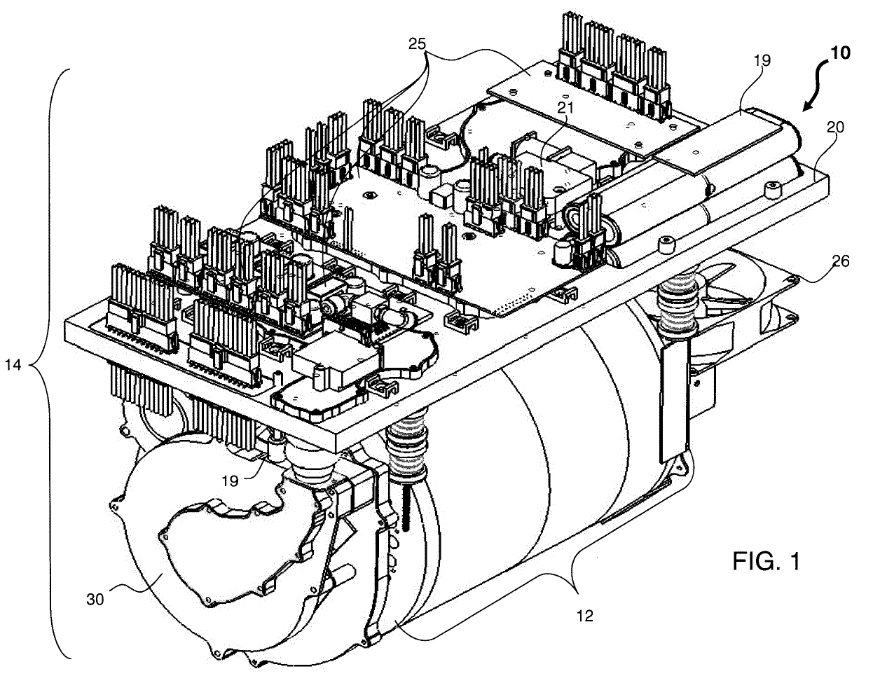

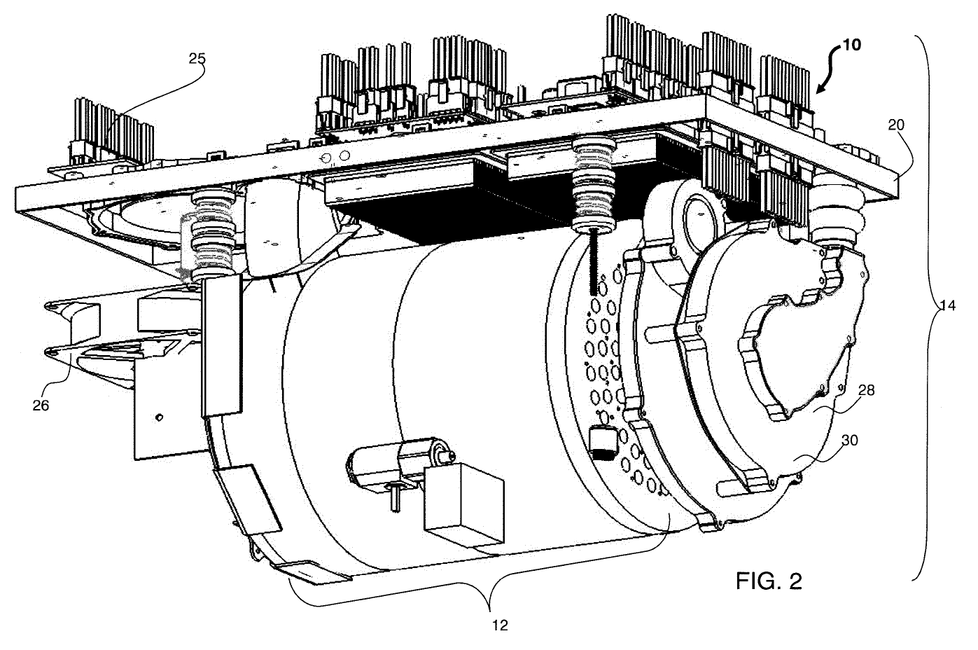

Referring now to the drawings, wherein the showings are for the purpose of illustrating certain exemplary embodiments only and not for the purpose of limiting the same, FIGS. 1 and 2 depict differing prospective views an exemplary fuel cell system 10. As will be discussed in further detail, the exemplary fuel cell system 10 has advanced integrated features providing substantial cost, weight and volume reduction over previous fuel cell system designs.

The fuel cell system 10 includes a fuel cell stack 12 and a balance of plant subsystem 14. The fuel cell stack 12 comprises the power generating component of the fuel cell system 10. The balance of plant subsystem 14 includes fuel and air management components of the fuel cell system 10, which deliver fuel and air to desired locations of the fuel cell stack 12 and can remove exhaust fluid from the fuel cell stack 12.

The balance of plant subsystem 14 includes an integrated air handling plate 20, a rechargeable battery 19, power electronics system 25, an exhaust blower 26, anode air/fuel delivery system 30, a user interface (not shown), heat management systems, environmentally sealed air, power and lines with wall passthroughs (not shown).

The rechargeable battery 19 can be any battery suitable for hybridization with the fuel cell stack 12 through the power electronics system 25. The rechargeable battery 19 can comprise any of several rechargeable battery technologies including, for example, nickel-cadmium, nickel-metal hydride, lithium-ion, and lithium-sulfur technologies. In alternative embodiments, other reversibly energy storage technologies such as ultra-capacitors can be utilized in addition to or instead of the rechargeable battery 19. Further in alternate embodiments, multiple energy storage devices can be utilized within a fuel cell system 10.

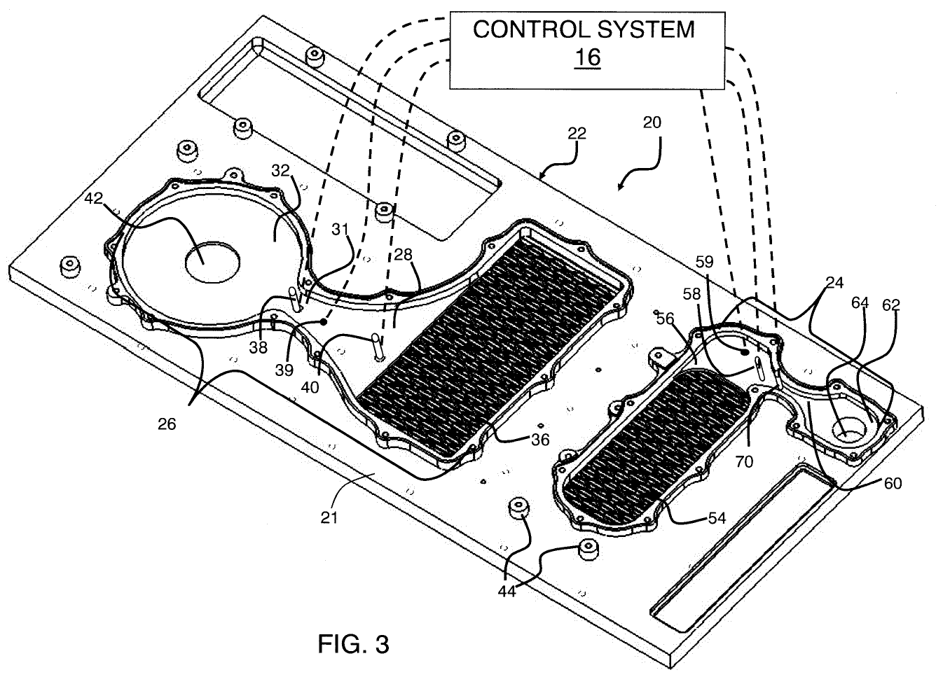

The power electronics system 25 includes an electrically conductive network configured to route power between the fuel cell stack 12 and the battery 19 and from the energy conversion devices (fuel cell stack 12 and the battery 19) to the face plate (not shown). Power levels within the power electronics 25 can be controlled utilizing power conversion members (not shown) controlled by a control system 16 (FIG. 3)

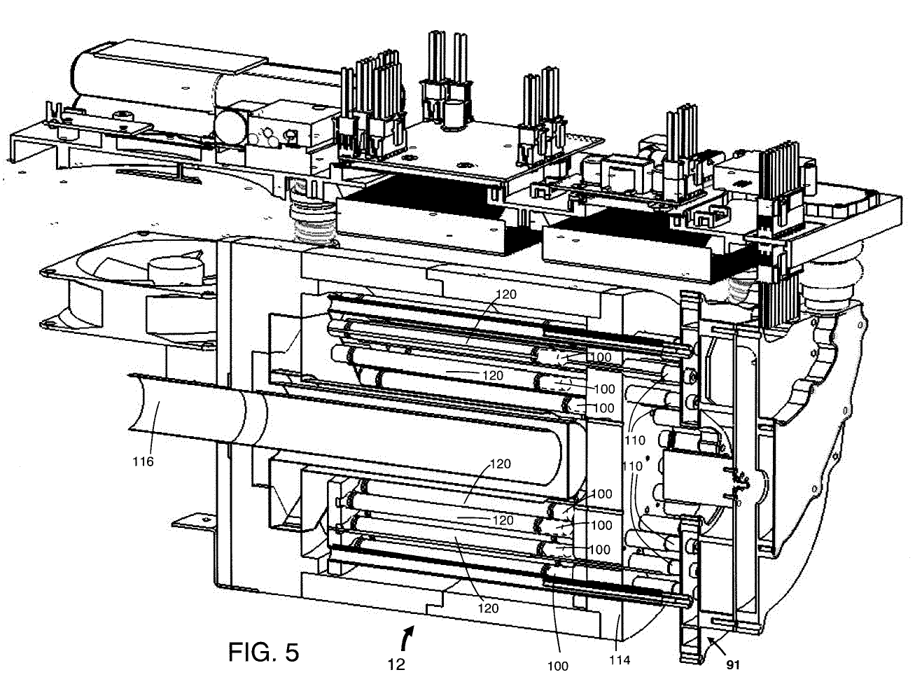

The exhaust blower 26 is configured to drive exhaust gases away from the fuel cell stack 12 in an exhaust flow path direction. In an exemplary embodiment the exhaust blower 26 is further configured to draw heat away from the integrated air handling plate 20. In an alternate embodiment, the integrated air handling plate 20 is positioned to intersect the exhaust flow path substantially perpendicular to the exhaust flow path direction such that the exhaust gases provide preheating to air within the integrated air handling plate 20. The anode air blower 28 is configured to motivate anode air at controlled flow rates to the fuel cell stack 12. The anode air/fuel delivery system 30 includes a fuel valve 21 (which is integrated into the plate member integrated air handling plate 200 and an air fuel mixing point 19. Fuel is delivered at controlled flow rates to the anode air/fuel delivery system 30 and is mixed with controlled amounts of air such that desired amounts of fuel along with a desired ratio of air to fuel is delivered to onboard reformers 100 (FIG. 5) of the fuel cell stack 12. The fuel level is controlled utilizing a fuel flow sensor and feedback control to actuate a fuel valve (not shown) to desired positions. Although the exemplary balance subsystem 14 is described having various exemplary actuators for motivating gases throughout the fuel cell system 10, it is to be understood that other types of actuators (for example, pumps, fans, and blowers) can be utilized to motivate gasses.

Referring to FIG. 3, a lower plate member 22 of the integrated plate member 20 includes a base plate 21 and elevated portions defining an anode air chamber 24 and a cathode air chamber 26. The elevated portions are cut from metal plates and attached to the base plate 21. The lower plate member 22 includes openings through the base plate 21 defining an anode blower opening 42, a cathode air filter opening 36, an anode air filter opening 54, and an anode blower opening 64.

The cathode air chamber 26 includes the cathode air filter opening 36, a first cathode air reservoir 28, an air pinch point portion 31, a second cathode air reservoir 32, and a cathode blower opening 42. The integrated air handling plate 20 further includes a first pressure sensor 38 and a second pressure sensor 40 coupled thereto. During operating, air is routed through the filter opening 36 to the cathode air reservoir 28 and is further routed downstream through the pinch point portion 31, through the reservoir 32 and out the blower opening 42. The pressure sensor 40 monitors a first pressure level indicative of air pressure within the cathode air reservoir 28. The pressure sensor 38 monitors a second pressure level indicative of air pressure at the pinch point portion 31.

A control system 16 can determine a flow rate through the pitch point portion 31 and therefore can determine a flow rate of air passing through the cathode air chamber 26 based on the first pressure level signal, the second pressure level signal, and the known cross-sectional area of the first cathode air reservoir 28 perpendicular to air flux and the cross-sectional area of the pinch point portion 31 perpendicular to air flux through the cathode air chamber 26. Specifically, the control system 16 utilizes the first and second pressure levels in the Bernoulli Equation along with specific calibrations to compensate for the compressibility of air. Utilizing pressure sensors at locations having differing cross-sectional areas provides significant cost reduction advantages (on the order of one tenth the cost) of traditional flow sensors to measure fluid flow within fuel cell systems.

The anode air chamber 24 includes the anode air filter opening 54, a first anode air reservoir 56, an air pinch point portion 70, a second anode air reservoir 62 and an anode blower opening 64. The integrated air handling plate 20 further includes a third pressure sensor 58 and a fourth pressure sensor 60 disposed within the anode air chamber 24. During operating, air is routed through the anode air filter opening 54 to the first anode air reservoir 56 and is further routed downstream through the pinch point portion 70, through the second anode reservoir 62 and out the anode blower opening 64. The third pressure sensor 58 monitors a third pressure level indicative of air pressure within the anode air reservoir 56. The fourth pressure sensor 60 monitors a fourth pressure level indicative of air pressure at the pinch point portion 70.

A control system 16 can determine a flow rate through the pinch point 70 and therefore can determine a flow rate of air passing through the cathode air chamber 24 based on the first pressure level signal, the second pressure level signal, and the known cross-sectional areas for fluid flow at the cathode air reservoir 56 and the pinch point portion 70.

Alternate designs can incorporate other flow sensor designs, including, for example, various mechanical and electromagnetic flow sensors, temperature-based flow sensors, ultrasonic flow sensors, and coriolis flow sensors can be utilized to measure air and fuel flow rates.

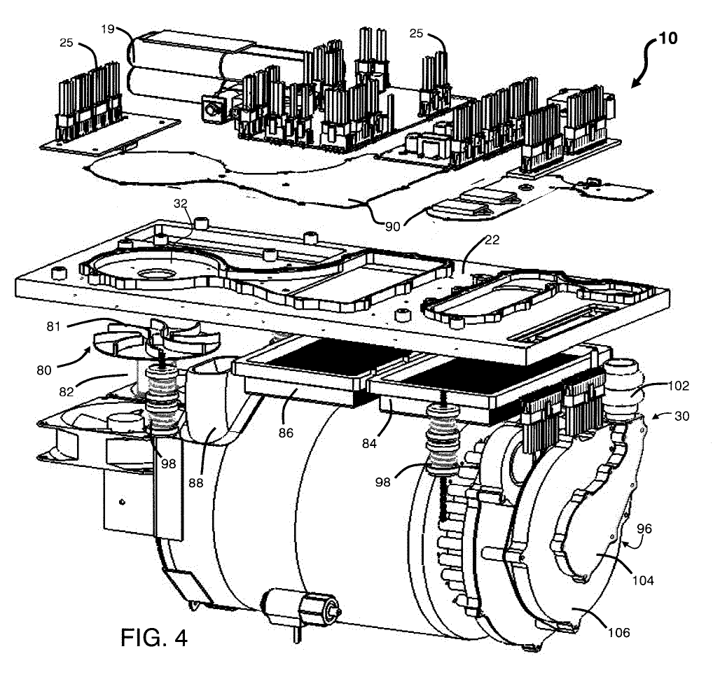

FIG. 4 depicts an exploded view of the integrated plate member 20 including a cathode blower assembly 80, an anode air filter 84, a cathode air filter 86, the lower plate portion 22, and upper plate portions 90.

During operation air enters an outer housing (not shown) of the fuel cell system 10 into a housing chamber wherein the air then travels through the anode air filter 84 and the cathode air filter 86. Air filtered through the anode air filter 84 is routed to the anode air chamber 24, and air filtered through the cathode air filter 86 is routed to the cathode air chamber 26. The anode and cathode air filter can comprise filters generally capable with removing particulates or other potentially substances from the air flow stream prior to utilization as an oxidant within the fuel cell system 10.

The cathode air blower assembly 80 includes a blower housing (not shown), a cathode air blower impeller 81 powered by an electric motor (not shown). The cathode air blower impeller 81 is mounted on a side of the lower plate portion 22 opposite the second cathode air reservoir 32 of the lower plate portion 22. The cathode air blower housing comprises a cut metal member coupled to the side of the lower plate member 22 thereby integrating the cathode air blower impeller 81 and blower impellers housing within the integrated air handling plate 20. The cathode air blower assembly 80 motivates the cathode air from the cathode blower chamber 32 through a resilient boot member 88 to the fuel cell stack 12. The integration of the cathode air blower assembly 80 within the integrated air handling plate 20 provides advantages in that cathode air blower assembly 80 provides cost advantages by utilizing sheet metal components and shared components with the lower plate member. In alternate embodiments portions of the integrated air handling plated can be formed from alternate materials such as polymer based materials and be formed through alternate processing, for example, injection molding and/or stamping. The integrated design reduces part count, decreasing assembly and manufacturing times and increasing manufacturing quality to reduce costs. The integration of the cathode air blower assembly within the integrated air handling plate 20 provides weight and size advantages when compared with non-integrated designs. Further, the integration of the cathode blower assembly 80 provides high mechanical strengths and high resistance to vibrational forces and ability to integrate active cooling to electrical components, to seal components and to integrate active cooling of electrical components.

The upper plate portions 90 comprises cut metal components that are fastened to lower plate portion 22 to enclose the anode air chamber 24 and cathode air chamber 26. Portions of the power electronics system 25 are mounted to the upper plate portions 90 proximate the anode chamber 24 and the cathode chamber 26. By mounting the power electronics proximate the air flow passageways, heat can be transferred away from the power electronics system and to the air in the anode air chamber 24 and the cathode air chamber 26 thereby providing benefits of removing heat form the power electronics system 25 and preheating the anode air stream and cathode air stream prior to providing the anode air flow stream and the cathode air flow streams to the fuel cell stack 12.

The balance of plant subsystem 14 is mechanically isolated from the fuel cell stack 12. The balance of plant subsystem 14 for each of anode air blowers are coupled to the fuel cell stack utilizing resilient members 98.

The anode air/fuel delivery system 30 includes an air/fuel mixing portion (not shown) and an air/fuel blower assembly 96 fluidly coupled to the integrated plate member 20 by a resilient member 102. The air/fuel blower assembly 96 includes an interface housing 104 and a blower housing 106. During operation fuel is routed through integrated plate member 20, through resilient member 102, through the air fuel mixing point 19, through the interface housing 104 and through the blower housing 106 and into the fuel cell stack 12. The blower housing included a motor-powered impellers (not shown) therein to motivate the air and the fuel from the integrated plate member to the fuel cell stack 12.

The exemplary fuel cell system 10 provides several features contributing to the ability to mass manufacture the fuel cell and contributing to energy-to-mass and energy to volume ratios and to high manufacturability. For example, the fuel cell system includes a substantially flat, integrated plate member that is easy to manufacture in that the integrated plate member is formed by cutting plates and coupling the plates together. Further, the design geometry allows for injection molding which allows for low part costs at high volumes.

The integrated plate member 20 includes a design that integrates several features of previous fuel cell systems. For example, the integrated plate member 20 includes channels for routing wherein previous designs included separate tubes and hoses to route fluid between system components. Further, the integrated plate member includes several mounting points for several subcomponents, wherein previous designs included separate brackets and housing portions for mounting. Further, the integrated plate has temperature management features that decreases stack volume over previous stack designs and requires less energy to manage temperature than previous stack designs. Still further, the integrated plate member requires fewer components and comprises low-cost, easy-to-manufacture sheet metal components (or alternate materials such as polymer-base material), which requires lower costs than previous system designs.

Referring to FIG. 5, the fuel cell stack 12 includes a manifold member 91 a fuel feed tube 110, an onboard fuel reformer 100, fuel cell tubes 120, tube support members 112, an insulated body 114, and recuperator 116.

The manifold member 91 is provided to receive air and fuel from the anode air/fuel delivery system 30 and to deliver the air and fuel mixture to each of the fuel feed tubes 110. The manifold member 91 is connected to each of the fuel cell feed tubes 110 such that a substantially gas-tight seal is maintained between an inner chamber of each fuel feed tubes 110 and an inner chamber of the manifold member 91. In one embodiment, the manifold member comprises a resilient member, for example, a flexible tube. The resilient member allows for movement of the plurality of fuel cell tubes connected to the manifold member relative to other fuel cell components. The resilient member can further dampen oscillations and reduce mechanical stresses on components of the fuel cell system due to movement of fuel cell components relative to each other. Movement of fuel cell components relative to each other can be caused by external forces on the fuel cell system (for example, vibrational movement), by thermal expansion mismatch between fuel cell system components and by fluid flow within the fuel cell system.

The fuel feed tubes 110 are disposed partially within the fuel cell tubes 120. The onboard fuel reformer 100 is positioned within each of the fuel cell tubes 120 proximate an electrochemically active area of the fuel cell tubes 120. The anode air and unreformed fuel is routed through the fuel feed tube 110 to the onboard fuel reformer 100 where the fuel is reformed and the resulting reformed fuel is heated during the exothermic reformation reactions (for an exemplary fuel cell system having an internal onboard fuel reformer, see U.S. patent application Ser. No. 10/979,017 which is hereby incorporated by reference herein.) In alternate embodiments, the fuel can be reformed utilizing endothermic reaction and the fuel cell tubes can be heated to operating temperatures utilizing alternate heating devices such as an internal combustor or a resistance heating device.

The fuel cell tubes 120 each comprise an anode layer, an electrolyte layer, and a cathode layer at the active portion that generates electromotive force at the active portion at operating temperatures in the range of 700 to 850 degrees Celsius. However, only the active portion of the fuel cell tube contains the anode layer, the electrolyte layer, and the cathode layer, and therefore, only a portion of the fuel cell tube requires high operating temperatures for generating electromotive force.

The insulated body 114 comprises composite insulation material that can maintain the fuel cell stack 12 at the operating temperatures. The recuperator 116 is provided to transfer heat between the exhaust gases generated within the fuel cell stack 12 and the cathode air stream inlet to the fuel cell stack 12. In an alternate embodiment, heat exchangers can be utilized to transfer heat between other fluid streams.

From the foregoing disclosure and detailed description of certain embodiments, it will be apparent that various modifications, additions and other alternative embodiments are possible without departing from the true scope and spirit of the invention. The embodiments discussed were chosen and described to provide illustrations of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A fuel cell system comprising:
a fuel reformer configured to react a raw fuel and oxygen to produce a reformed fuel;
a fuel cell configured to generate electricity by reacting oxygen at a first electrode and reformed fuel at a second electrode;
a plate member at least partially defining an air chamber wall, an air chamber inlet, and an air chamber outlet, the air chamber being configured to route air to at least one of the fuel reformer and the first electrode of the fuel cell stack; and
a first air actuator configured to motivate air flow from the inner chamber to at least one of the fuel reformer and the first electrode of the fuel cell stack.

2. The fuel cell system of claim 1, further comprising a control system signally communicating with the first air actuator, the control system being configured to determine an air actuation level and to control operation of the first air actuator based on the determined air actuation level.

3. The fuel cell system of claim 2, further comprising a first pressure sensor disposed within the inner chamber configured to measure a pressure level within the inner chamber and a second pressure sensor disposed within the air flow path downstream the inner chamber such that the control system can determine the air flow level of air exiting the inner chamber by monitoring the first pressure sensor and the second pressure sensor.

4. The fuel cell system of claim 2, further comprising a sensor configured to detect a fuel cell operating condition, said sensor signally communicating with the control system, wherein the control system is configured to determine the air actuation level based on the detected fuel cell system operating condition.

5. The fuel cell system of claim 4, wherein the fuel cell operating condition comprises one of a temperature level, a fuel flow rate, a pressure level, and a fuel cell power level.

6. The fuel cell system of claim 2, further comprising a control system signally communicating with the first air actuator, the control system being configured to determine an air actuation level and to control operation of the first air actuator based on the determined air actuation level.

7. The fuel cell system of claim 2, further comprising a second air actuator, wherein the control system controls the first and second air actuators to control air flow from into the inner chamber from the air inlet and from the inner chamber to the first air outlet and the second air outlet.

8. The fuel cell system of claim 1, wherein the first air actuator is disposed upstream the inner chamber.

9. The fuel cell system of claim 1, comprising a second plate member, wherein the second plate member comprises the at least one wall of the inner chamber.

10. The fuel cell system of claim 9, wherein the plate member is substantially planar and wherein the plate member defines a top wall and a bottom wall of the inner chamber.

11. The fuel cell system of claim 10, wherein an electric device is disposed on one of the top wall and the bottom wall of the inner chamber of the fuel cell stack.

12. The fuel cell system of claim 11, wherein the plate member comprises a plurality of metal plates, and wherein a milled portion of at least one of the plurality of metal plates defines at least a portion of the inner chamber.

13. The fuel cell system of claim 9, wherein the plate member defines an air actuator chamber, wherein the air actuator is disposed within the air actuator chamber.

14. The fuel cell system of claim 8, further comprising a filter member mounted to the plate member, such that air is routed through the filter prior to being routed to the inner chamber.

15. The fuel cell system of claim 1, comprising a plurality of tubular solid oxide fuel cells, wherein the first air outlet routes fuel to an outer electrode of the tubular solid oxide fuel cell and the second air outlet routes fuel to an inner electrode of the tubular solid oxide fuel cell.

16. The fuel cell system of claim 15, further comprising a fuel delivery member, wherein fuel is provided by the fuel delivery member to the air routed to the inner electrode of the solid oxide fuel cell downstream the fuel cell system and upstream the fuel reformer.

17. A solid oxide fuel cell system comprising:
a fuel cell configured to generate electricity;
a plate member defining an air chamber, an air chamber inlet, a first air chamber outlet, and an air actuator housing; and
an air actuator disposed within the air actuator housing configured to motivate the air from the air chamber to the fuel cell stack.

18. The solid oxide fuel cell system of claim 17, further comprising controlling an air actuation level of the first air actuator, said control system configured to determine an air actuation level and to command the air actuator based on the determined air actuation level.

19. The solid oxide fuel cell of claim 17, wherein the inner chamber is defined by milled areas of two metal sheets.

20. A solid oxide fuel cell comprising:
an fuel reformer configured to react a raw fuel and oxygen to produce a reformed fuel;
a fuel cell configured to generate electricity by reacting oxygen at a first electrode and reformed fuel at a second electrode;
a least one inner wall defining an air chamber, an air chamber inlet, a first air chamber outlet, and a second air chamber outlet, the first air chamber outlet being configured to route air to the fuel reformer, the second air chamber being configured to route air to the air electrode of the fuel cell stack; and
a first air actuator configured to motivate air flow from the inner chamber to at least one of the first air chamber outlet and the second air chamber outlet.
